(19) United States
(12) Patent Application Publication
(10) Pub. No.: US 2026/0262100 A1
(43) Pub. Date: Sep. 3, 2026

(54) METHOD FOR RANDOM ACESS IN SUB-BAND FULL DUPLEX SLOT IN MOBILE COMMUNICATIONS

(71) Applicant: MEDIATEK SINGAPORE PTE. LTD., Singapore (SG)

(72) Inventors: Sumaila Anning MAHAMA, Cambridge (GB); Yi-Hsien LIN, Hsinchu City (TW); Mohammed S Aleabe AL-IMARI, Cambridge (GB); Jozsef Gabor NEMETH, Cambridge (GB)

(73) Assignee: MEDIATEK SINGAPORE PTE. LTD., Singapore (SG)

(21) Appl. No.: 19/474,511

(22) PCT Filed: Jul. 29, 2024
(86) PCT No.: PCT/CN2024/108067

§ 371 Date: Oct. 10, 2025

Related U.S. Application Data
(60) Provisional application No. 63/518,573, filed on Aug. 10, 2023.

(51) Int. Cl. H04W 74/0833; H04B 17/318; H04L 5/14

(52) U.S. Cl. CPC H04W 74/0833; H04B 17/318; H04L 5/1438

(57) ABSTRACT

Various solutions for random access in sub-band full duplex (SBFD) slot with respect to an apparatus in mobile communications are described. The apparatus may determine whether a state of the apparatus meets a condition. The apparatus may determine to transmit a physical random access channel (PRACH) within a SBFD slot to a network in an event that the state of the apparatus meets the condition.

### CROSS REFERENCE TO RELATED PATENT APPLICATION(S)

The present disclosure is part of a non-provisional application claiming the priority benefit of U.S. Patent Application No. 63/518,573, filed 10 Aug. 2023, the content of which herein being incorporated by reference in its entirety.

### TECHNICAL FIELD

The present disclosure is generally related to mobile communications and, more particularly, to random access in sub-band full duplex (SBFD) slot with respect to apparatus in mobile communications.

### BACKGROUND

Unless otherwise indicated herein, approaches described in this section are not prior art to the claims listed below and are not admitted as prior art by inclusion in this section.

In 5^{th}-generation (5G) New Radio (NR) mobile communications, sub-band full duplex (SBFD) technology is introduced. Generally, SBFD technology may allow uplink (UL) and downlink (DL) transmissions within the same frequency band, thereby enhancing spectral efficiency and system capacity.

In some scenarios, random access procedure may be perform based on SBFD technology. Specifically, the message of random access procedure (e.g., random access message-1 which includes a physical random access channel (PRACH) preamble) may be transmitted within SBFD slot(s)/symbol(s), which may improve random access performance.

However, message transmission during random access procedure may cause significant interference, especially inter-user equipment-cross link interference (inter-UE-CLI). For example, regarding UE in an idle mode, the base station may not be able to mitigate CLI due to uncertainty of aggressor UE transmitting message of random access procedure (e.g., especially for contention-based random access procedure), and CLI handling procedure may be inefficient.

Accordingly, how to reduce the interferences during random access procedure within SBFD slot(s)/symbol(s) becomes an important issue in the newly developed wireless communication network. Therefore, there is a need to provide proper schemes to avoid and reduce interferences for random access procedure in SBFD communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to random access in sub-band full duplex (SBFD) slot with respect to apparatus in mobile communications.

In one aspect, a method may involve an apparatus determining whether a state of the apparatus meets a condition. The method may also involve the apparatus determining a physical random access channel (PRACH) within an SBFD slot to a network in an event that the state of the apparatus meets the condition.

In one aspect, an apparatus may comprise a transceiver which, during operation, wirelessly communicates with at least one UE of a wireless network. The apparatus may also comprise a processor communicatively coupled to the transceiver. The processor, during operation, may perform operations comprising determining whether a state of the apparatus meets a condition. The processor may also perform operations comprising determining a PRACH within an SBFD slot to a network in an event that the state of the apparatus meets the condition.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to random access in sub-band full duplex (SBFD) slot with respect to apparatus in mobile communications. According to the present disclosure, a number of possible solutions may be implemented separately or jointly. That is, although these possible solutions may be described below separately, two or more of these possible solutions may be implemented in one combination or another.

Regarding to the present disclosure, a physical random access channel (PRACH) (e.g., random access message-1 which includes a PRACH preamble) may be transmitted within an SBFD slot in an event that a state of a user equipment (UE) meets a pre-determined condition. In particular, the UE may determine whether the state, which is related to interference, meets the condition. If positive, it means that interference may not be significantly caused when the PRACH is transmitted within the SBFD slot. Accordingly, the UE may transmit the PRACH within the SBFD slot. If negative, it means that significant interferences may be caused when the PRACH is transmitted within the SBFD slot. Accordingly, the UE may not transmit the PRACH within the SBFD slot but may instead transmit the PRACH within a legacy time division duplexing (TDD) slot.

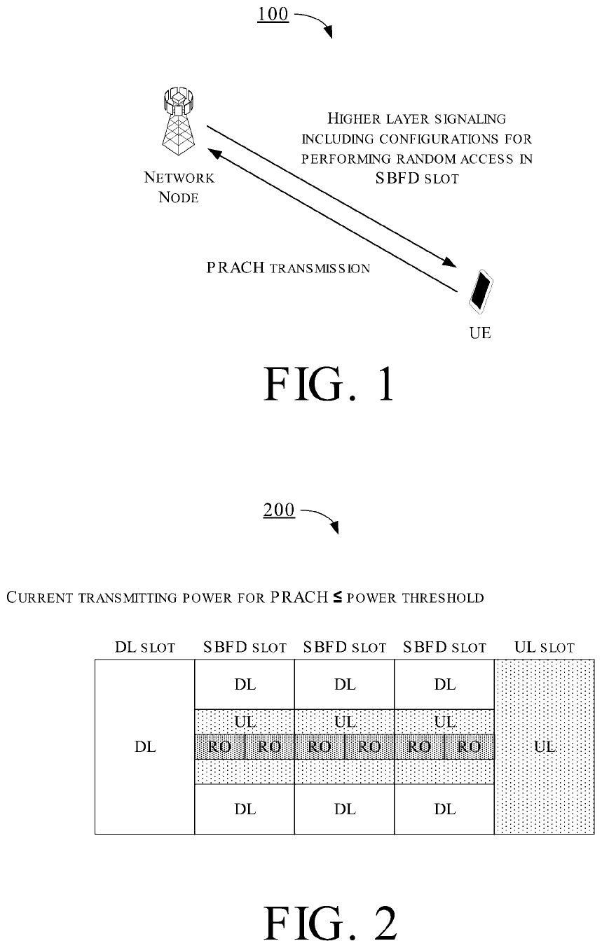

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the UE may receive a higher layer signaling (e.g., radio resource control (RRC) configuration, system information block (SIB), etc.) including configuration(s) associated with a condition from the network node. Under different modes (e.g., idle mode, active mode (connected mode) and inactive mode), before performing a random access procedure with the network node, the UE may determine whether a state, which is related to interference (e.g., inter-UE-cross link interference (inter-UE-CLI)), of the UE meets the condition. If the state is determined to meet the condition, it means that interference may not be significantly caused when a PRACH of the random access procedure is transmitted within an SBFD slot. Accordingly, the UE may transmit the PRACH within the SBFD slot for the random access procedure. If the state is determined not to meet the condition, it means that significant interferences may be caused when the PRACH is transmitted within the SBFD slot. Accordingly, the UE may not transmit the PRACH within the SBFD slot but may instead transmit the PRACH within a legacy TDD slot for the random access procedure.

FIG. 2 illustrates an example scenario 200 under schemes in accordance with implementations of the present disclosure. In some embodiments, the state related to the interference may include a transmitting power for the PRACH, and the configuration associated with the condition may include a power threshold. Specifically, the network node may pre-configure the power threshold to the UE by the higher layer signaling to the UE. Accordingly, regardless of modes (e.g., idle mode, active mode (connected mode) and inactive mode), when the UE needs to perform the random access procedure with the network node, the UE may determine whether the current transmitting power configured for the PRACH falls below the power threshold.

In some cases, if the current transmitting power configured for the PRACH falls below the power threshold, it means that the interference may not be significantly caused when the PRACH of the random access procedure is transmitted within an SBFD slot. Therefore, the UE may determine to transmit the PRACH via at least one PRACH occasion (RO) within the SBFD slot to the network node for the random access procedure.

In some cases, if the current transmitting power configured for the PRACH does not fall below the power threshold, it means that the interference may be significantly caused when the PRACH of the random access procedure is transmitted within the SBFD slot. Therefore, the UE may determine not to transmit the PRACH within the SBFD slot to the network node for the random access procedure. Instead, the UE may transmit the PRACH within the legacy TDD uplink slot to the network node for the random access procedure.

In some cases, if (1) the current transmitting power configured for the PRACH does not fall below the power threshold (i.e., the current transmitting power configured for the PRACH exceeds the power threshold), and (2) a PRACH preamble format (e.g., PRACH preamble Format 0 defined in 3GPP specification) of the PRACH is with a slight bandwidth, it means that the interference may not be significantly caused when the PRACH of the random access procedure is transmitted within the SBFD slot. Therefore, the UE may determine to transmit the PRACH using slight bandwidth within the SBFD slot to the network node for the random access procedure.

In some cases, if the current transmitting power configured for another PRACH does not fall below the power threshold during a PRACH power ramping procedure (i.e., the current transmitting power configured for the another PRACH exceeds the power threshold during the PRACH power ramping procedure), it means that, during the PRACH power ramping procedure, the interference may be significantly caused when the another PRACH of the random access procedure is transmitted within the SBFD slot. Therefore, the UE may stop to transmit the another PRACH within the SBFD slot to the network node for the random access procedure during the PRACH power ramping procedure. In addition, when the current transmitting power for the another PRACH falls below the power threshold after suspending the PRACH power ramping procedure, the UE may determine to transmit the another PRACH within the SBFD slot to the network node.

In some implementations, the power threshold may be determined based on a preamble received target power (i.e., a parameter of preambleReceivedTargetPower defined in 3GPP specification) or an inter-UE-CLI. In some cases, the power threshold may be determined to be higher than a value of the preamble received target power. In some cases, the power threshold may be determined to ensure minimal inter-UE CLI or to eliminate the inter-UE CLI.

In some implementations, the power threshold may be configured per PRACH occasion or per PRACH preamble format. More specifically, the power threshold may be variable based on different PRACH occasions or different PRACH preamble formats.

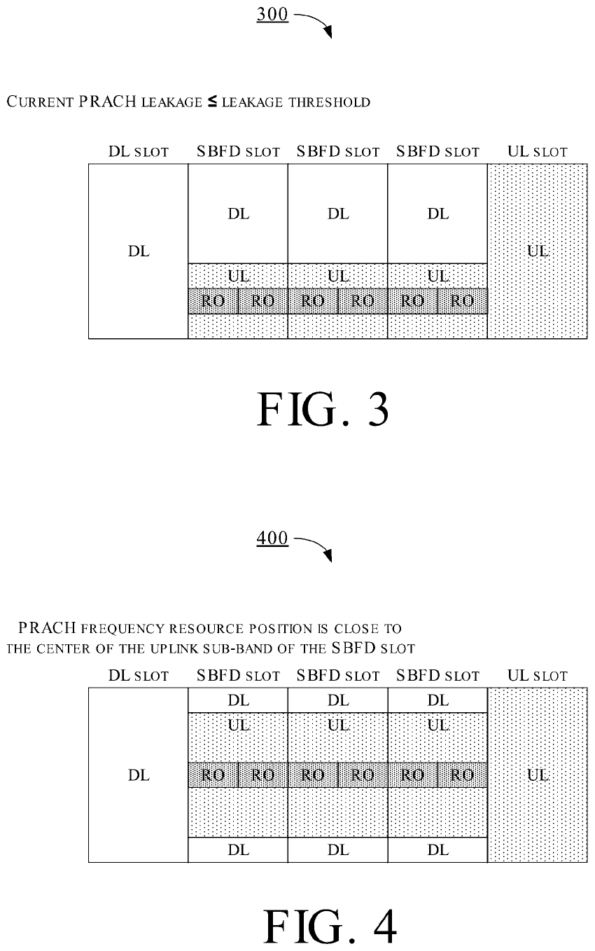

FIG. 3 illustrates an example scenario 300 under schemes in accordance with implementations of the present disclosure. In some embodiments, the state related to the interference may include a PRACH leakage, and the configuration associated with the condition may include a leakage threshold. Specifically, the network node may pre-configure the leakage threshold to the UE by the higher layer signaling. Accordingly, regardless of modes (e.g., idle mode, active mode (connected mode) and inactive mode), when the UE needs to perform the random access procedure with the network node, the UE may determine whether the PRACH leakage falls below the leakage threshold.

In some cases, if the PRACH leakage falls below the leakage threshold, it means that the interference may not be significantly caused when the PRACH of the random access procedure is transmitted within an SBFD slot. Therefore, the UE may determine to transmit the PRACH via at least one RO within the SBFD slot to the network node for the random access procedure.

In some cases, if the PRACH leakage does not fall below the PRACH threshold, it means that the interference may be significantly caused when the PRACH of the random access procedure is transmitted within the SBFD slot. Therefore, the UE may determine not to transmit the PRACH within the SBFD slot to the network node for the random access procedure. Instead, the UE may transmit the PRACH within the legacy TDD slot to the network node for the random access procedure.

In some cases, if (1) the PRACH leakage does not fall below the leakage threshold (i.e., the PRACH leakage exceeds the leakage threshold), and (2) a PRACH preamble format (e.g., PRACH preamble Format 0 defined in 3GPP specification) of the PRACH is with a slight bandwidth, it means that the interference may not be significantly caused when the PRACH of the random access procedure is transmitted within the SBFD slot. Therefore, the UE may determine to transmit the PRACH using slight bandwidth within the SBFD slot to the network node for the random access procedure.

In some implementations, the leakage threshold may be determined based on a level of in-band emission or an inter-UE-CLI. In some cases, the leakage threshold may be determined to be lower than the level of in-band emission. In some cases, the leakage threshold may be determined to ensure minimal inter-UE CLI or to eliminate the inter-UE CLI. For example, in-band emission is defined: (1) as an average emission across 12 sub-carriers (i.e., 1 resource block); and (2) as a function of resource block offset from an edge of allocated uplink transmission bandwidth. The in-band emission is measured as a ratio of a UE output power in a non-allocated resource block to a UE output power in an allocated resource block. The average of the in-band emission measurement should not exceed the corresponding values specified in 3GPP specification. In some scenarios, wider resource block allocation may cause higher leakage and resource blocks close to the edge of allocated uplink transmission bandwidth may experience higher leakage.

In some implementations, the PRACH leakage may include a leakage on a first resource block of downlink sub-band within the SBFD slot. In some implementations, the PRACH leakage may include a leakage on a reference resource.

FIG. 4 illustrates an example scenario 400 under schemes in accordance with implementations of the present disclosure. In some embodiments, the state related to the interference may include a PRACH frequency resource position (e.g., a frequency resource position of RO), and the configuration associated with the condition may include a center of an uplink sub-band of an SBFD slot. Specifically, regardless of modes (e.g., idle mode, active mode (connected mode) and inactive mode), when the UE needs to perform the random access procedure with the network node, the UE may determine whether the PRACH frequency resource position is close to the center of the uplink sub-band of the SBFD slot.

In some cases, if the PRACH frequency resource position is close to the center of the uplink sub-band of the SBFD slot, it means that the interference may not be significantly caused when the PRACH of the random access procedure is transmitted within the SBFD slot. Therefore, the UE may determine to transmit the PRACH within the SBFD slot to the network node for the random access procedure.

In some cases, if the PRACH frequency resource position is not close to the center of the uplink sub-band of the SBFD slot (i.e., if the PRACH frequency resource position is close to an edge of the uplink sub-band of the SBFD slot), it means that the interference may be significantly caused when the PRACH of the random access procedure is transmitted within the SBFD slot. Therefore, the UE may determine not to transmit the PRACH within the SBFD slot to the network node for the random access procedure. Instead, the UE may transmit the PRACH within the legacy TDD slot to the network node for the random access procedure.

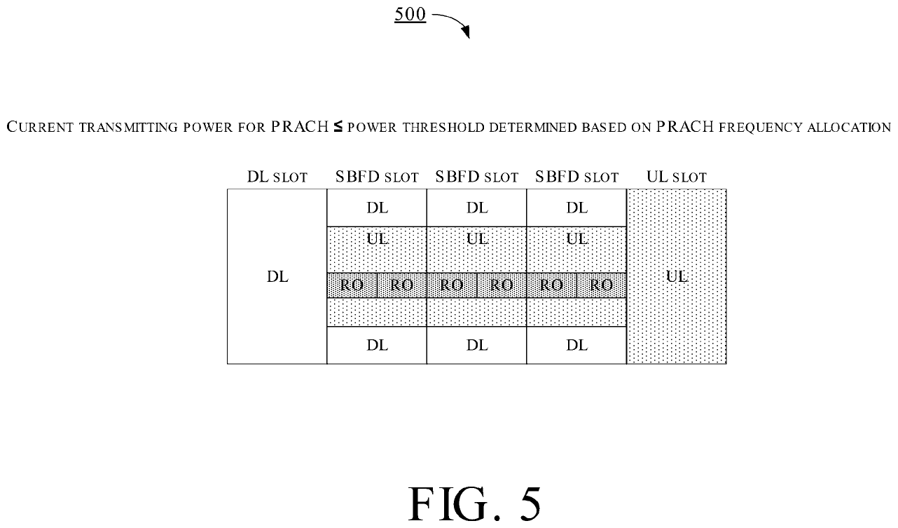

FIG. 5 illustrates an example scenario 500 under schemes in accordance with implementations of the present disclosure. In some embodiments, the state related to the interference may include a transmitting power for the PRACH, and the configuration associated with the condition may include a power threshold determined based on a PRACH frequency resource allocation. Specifically, the network node may pre-configure a plurality of power thresholds to the UE by the higher layer signaling. The UE may determine the power threshold from the plurality of power thresholds based on the current PRACH frequency resource allocation. Accordingly, regardless of modes (e.g., idle mode, active mode (connected mode) and inactive mode), when the UE needs to perform the random access procedure with the network node, the UE may determine whether the current transmitting power configured for the PRACH falls below the power threshold.

In some implementations, the PRACH frequency resource allocation may include at least one of a center of an uplink sub-band of the SBFD slot and a number of resource blocks allocated for the PRACH.

Regarding the PRACH frequency resource allocation including the center of an uplink sub-band of the SBFD slot, the network node may pre-configure a look-up table to the UE by the higher layer signaling. The look-up table may include relations between the plurality of power thresholds and a plurality of PRACH frequency resource positions. The UE may determine the power threshold based on the current PRACH frequency resource position according to the look-up table. For example, the UE may: (1) determine the power threshold to be a first value when the current PRACH frequency resource position is close to the center of the uplink sub-band of the SBFD slot, or (2) determine the power threshold to be a second value when the PRACH frequency resource position is not close to the center of the uplink sub-band of the SBFD slot (i.e., when the PRACH frequency resource position is close to an edge of the uplink sub-band of the SBFD slot), while the second value may be lower than the first value. In other words, the power threshold may be determined higher when PRACH frequency resource position is close to the center of the uplink sub-band of the SBFD slot, and the power threshold may be determined lower when PRACH frequency resource is close to the edge of the uplink sub-band of the SBFD slot.

Regarding the PRACH frequency resource allocation including the number of resource blocks allocated for PRACH, the network node may pre-configure a look-up table to the UE by the higher layer signaling. The look-up table may include relations between the plurality of power thresholds and a plurality of numbers of resource blocks allocated for PRACH. The UE may determine the power threshold based on the current number of resource blocks allocated for PRACH according to the look-up table. For example, the UE may: (1) determine the power threshold to be a first value when the current number of resource blocks allocated for PRACH is equal to a first number, or (2) determine the power threshold to be a second value when the current number of resource blocks allocated for PRACH equal to a second number which is lower than the first number, while the first value may be lower than the second value. In other words, the power threshold may be determined higher when the number of resource blocks allocated for PRACH is configured lower, and the power threshold may be determined lower when the number of resource blocks allocated for PRACH is configured higher.

Regarding the PRACH frequency resource allocation including the PRACH frequency resource position and the number of resource blocks allocated for PRACH, the network node may pre-configure a look-up table to the UE by the higher layer signaling. The look-up table may include relations between the plurality of power thresholds, the plurality of PRACH frequency resource positions and the plurality of numbers of resource blocks allocated for PRACH. The UE may determine the power threshold based on the current PRACH frequency resource position and the current number of resource blocks allocated for PRACH according to the look-up table. For example, the UE may: (1) determine the power threshold to be a first value when the current PRACH frequency resource position is close to the center of the uplink sub-band of the SBFD slot and the current number of resource blocks allocated for PRACH is equal to a first number, or (2) determine the power threshold to be a second value when the current PRACH frequency resource position is not close to the center of the uplink sub-band of the SBFD slot (i.e., the current PRACH frequency resource position is close to the edge of the uplink sub-band of the SBFD slot) and the current number of resource blocks allocated for PRACH equal to a second number which is lower than the first number, while the first value may be lower than the second value. In other words, the power threshold may be determined higher when the current PRACH frequency resource position is close to the center of the uplink sub-band of the SBFD slot and the number of resource blocks allocated for PRACH is configured lower, and the power threshold may be determined lower when the current PRACH frequency resource position is not close to the center of the uplink sub-band of the SBFD slot and the number of resource blocks allocated for PRACH is configured higher.

In some cases, if the current transmitting power configured for the PRACH falls below the power threshold determined based on the PRACH frequency resource allocation, it means that the interference may not be significantly caused when the PRACH of the random access procedure is transmitted within an SBFD slot. Therefore, the UE may determine to transmit the PRACH within the SBFD slot to the network node for the random access procedure.

In some cases, if the current transmitting power configured for the PRACH does not fall below the power threshold determined based on the PRACH frequency resource allocation, it means that the interference may be significantly caused when the PRACH of the random access procedure is transmitted within the SBFD slot. Therefore, the UE may determine not to transmit the PRACH within the SBFD slot to the network node for the random access procedure. Instead, the UE may transmit the PRACH within the legacy TDD slot to the network node for the random access procedure.

### Illustrative Implementations

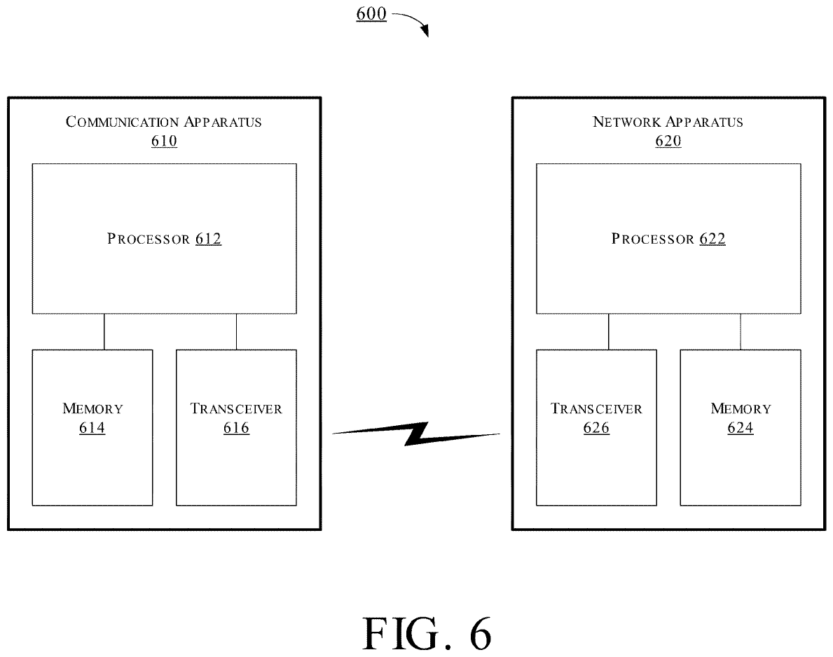

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to random access in SBFD slot with respect to UE and network apparatus in mobile communications, including scenarios/schemes described above as well as process 700 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of a network apparatus, which may be a network node such as a satellite, a base station, a small cell, a router or a gateway. For instance, network apparatus 620 may be implemented in an eNodeB in an LTE network, in a gNB in a 5G/NR, IoT, NB-IoT or IIoT network or in a satellite or base station in a 6G network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including autonomous reliability enhancements in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

### Illustrative Processes

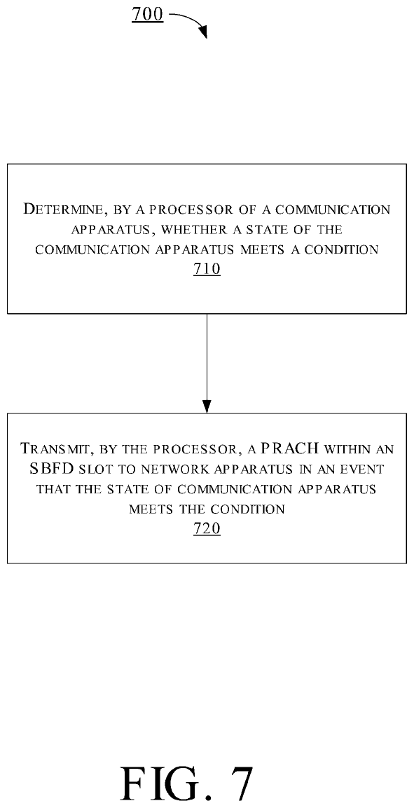

FIG. 7 illustrates an example process 700 in accordance with an implementation of the present disclosure. Process 700 may be an example implementation of above scenarios/schemes, whether partially or completely, with respect to random access in SBFD slot of the present disclosure. Process 700 may represent an aspect of implementation of features of communication apparatus 610. Process 700 may include one or more operations, actions, or functions as illustrated by one or more of blocks 710 to 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At block 710, process 700 may involve processor 612 of communication apparatus 610 determining whether a state of communication apparatus 610 meets a condition. Process 700 may proceed from block 710 to block 720.

At block 720, process 700 may involve processor 612 of communication apparatus 610 transmitting a PRACH within an SBFD slot to network apparatus 620 in an event that the state of communication apparatus 610 meets the condition.

In some implementations, the state of communication apparatus 610 may include a transmitting power for the PRACH and the condition may include a power threshold. Process 700 may involve processor 612 determining whether the transmitting power for the PRACH falls below the power threshold. Process 700 may involve processor 612 transmitting the PRACH within the SBFD slot to network apparatus 620 in the event that the transmitting power for the PRACH falls below the power threshold.

In some implementations, the power threshold may be determined based on a preamble received target power or an inter UE-CLI.

In some implementations, the power threshold may be configured per PRACH occasion or per PRACH preamble format.

In some implementations, process 700 may involve processor 612 transmitting the PRACH within the SBFD slot to network apparatus 620 in the event that the transmitting power for the PRACH exceeds the power threshold and a PRACH preamble format of the PRACH is with a slight bandwidth.

In some implementations, process 700 may involve processor 612 stopping transmitting another PRACH within the SBFD slot to network apparatus 620 in the event that the transmitting power for the another PRACH does not fall below the power threshold during a PRACH power ramping procedure.

In some implementations, process 700 may involve processor 612 transmitting the PRACH within the SBFD slot to network apparatus 620 in an event that the transmitting power for the another PRACH falls below the power threshold after suspending the PRACH power ramping procedure.

In some implementations, the state of communication apparatus 610 may include a PRACH leakage and the condition may include a leakage threshold. Process 700 may involve processor 612 determining whether the PRACH leakage falls below the leakage threshold. Process 700 may involve processor 612 transmitting the PRACH within the SBFD slot to network apparatus 620 in the event that the PRACH leakage falls below the leakage threshold.

In some implementations, the leakage threshold may be determined based on a level of in-band emission or an inter UE-CLI.

In some implementations, the PRACH leakage may include a leakage on a first resource block of downlink sub-band or a leakage on a reference resource.

In some implementations, process 700 may involve processor 612 determining to transmit the PRACH within the SBFD slot to network apparatus 620 in the event that the PRACH leakage exceeds the leakage threshold and a PRACH preamble format of the PRACH is with a slight bandwidth.

In some implementations, the state of communication apparatus 610 may includes a PRACH frequency resource position and the condition may include a center of an uplink sub-band of the SBFD slot. Process 700 may involve processor 612 determining whether the PRACH frequency resource position is close to the center of the uplink sub-band of the SBFD slot. Process 700 may involve processor 612 transmitting the PRACH within the SBFD slot to network apparatus 620 in the event that the PRACH frequency resource position is close to the center of the uplink sub-band of the SBFD slot.

In some implementations, the state of communication apparatus 610 may include a transmitting power for the PRACH and the condition may include a power threshold determined based on a PRACH frequency resource allocation. Process 700 may involve processor 612 determining whether the transmitting power for the PRACH falls below the power threshold determined based on the PRACH frequency resource allocation. Process 700 may involve processor 612 transmitting the PRACH within the SBFD slot to network apparatus 620 in the event that the transmitting power for the PRACH falls below the power threshold determined based on the PRACH frequency resource allocation.

In some implementations, the PRACH frequency resource allocation may include at least one of a center of an uplink sub-band of the SBFD slot and a number of resource blocks allocated for PRACH.

In some implementations, process 700 may involve processor 612 determining the power threshold according to the center of the uplink sub-band of the SBFD slot, wherein: (1) the power threshold is determined to be a first value in an event that a PRACH frequency resource position is close to the center of the uplink sub-band of the SBFD slot, or (2) the power threshold is determined to be a second value in an event that the PRACH frequency resource position is not close to the center of the uplink sub-band of the SBFD slot, and the second value is lower than the first value.

In some implementations, the power threshold may be determined based on a look-up table including relations between a plurality of power thresholds and a plurality of PRACH frequency resource positions.

In some implementations, process 700 may involve processor 612 determining the power threshold according to the number of resource blocks allocated for PRACH, wherein: (1) the power threshold is determined to be a first value in an event that the number of resource blocks allocated for PRACH is equal to a first number, or (2) the power threshold is determined to be a second value in an event that the number of resource blocks allocated for PRACH is equal to a second number which is lower than the first number, wherein the first value is lower than the second value.

In some implementations, the power threshold may be determined based on a look-up table including relations between a plurality of power thresholds and a plurality of numbers of resource blocks allocated for PRACH.

In some implementations, process 700 may involve processor 612 determining the power threshold according to the center of the uplink sub-band of the SBFD slot and the number of resource blocks allocated for PRACH, wherein: (1) the power threshold is determined to be a first value in an event that a PRACH frequency resource position is close to the center of the uplink sub-band of the SBFD slot and the number of resource blocks allocated for PRACH is equal to a first number, or (2) the power threshold is determined to be a second value in an event that the PRACH frequency resource position is not close to the center of the uplink sub-band of the SBFD slot and the number of resource blocks allocated for PRACH is equal to a second number which is lower than the first number, wherein the first value is lower than the second value.

In some implementations, the power threshold may be determined based on a look-up table including relations between a plurality of power thresholds, a plurality of PRACH frequency resource positions and a plurality of numbers of resource blocks allocated for PRACH.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, whether a state of the apparatus meets a condition; and
transmitting, by the processor, a physical random access channel (PRACH) within a sub-band full duplex (SBFD) slot to a network in an event that the state of the apparatus meets the condition.

2. The method of claim 1, wherein the state of the apparatus includes a transmitting power for the PRACH, the condition includes a power threshold, and the step of determining whether the state of the apparatus meets the condition includes:
determining whether the transmitting power for the PRACH falls below the power threshold;
wherein the step of transmitting the PRACH within the SBFD slot to the network in the event that the state of the apparatus meets the condition includes:
transmitting the PRACH within the SBFD slot to the network in the event that the transmitting power for the PRACH falls below the power threshold.

3. The method of claim 2, wherein the power threshold is determined based on a preamble received target power or an inter user equipment-cross link interference (UE-CLI).

4. The method of claim 2, wherein the power threshold is configured per PRACH occasion or per PRACH preamble format.

5. The method of claim 1, wherein the state of the apparatus includes a transmitting power for the PRACH, the condition includes a power threshold, and the step of determining whether the state of the apparatus meets the condition includes:
determining whether the transmitting power for the PRACH exceeds the power threshold,
wherein the step of transmitting the PRACH within the SBFD slot to the network in the event that the state of the apparatus meets the condition includes:
transmitting the PRACH within the SBFD slot to the network in the event that the transmitting power for the PRACH exceeds the power threshold and a PRACH preamble format of the PRACH is with a slight bandwidth.

6. The method of claim 2, further comprising:
stopping, by the processor, transmitting another PRACH within the SBFD slot to the network in the event that the transmitting power for the another PRACH does not fall below the power threshold during a PRACH power ramping procedure.

7. The method of claim 6, further comprising:
transmitting, by the processor, the another PRACH within the SBFD slot to the network in an event that the transmitting power for the another PRACH falls below the power threshold after suspending the PRACH power ramping procedure.

8. The method of claim 1, wherein the state of the apparatus includes a PRACH leakage, the condition includes a leakage threshold, and the step of determining whether the state of the apparatus meets the condition includes:
determining whether the PRACH leakage falls below the leakage threshold,
wherein the step of transmitting the PRACH within the SBFD slot to the network in the event that the state of the apparatus meets the condition includes:
transmitting the PRACH within the SBFD slot to the network in the event that the PRACH leakage falls below the leakage threshold.

9. The method of claim 8, wherein the leakage threshold is determined based on a level of in-band emission or an inter user equipment-cross link interference (UE-CLI).

10. The method of claim 8, wherein the PRACH leakage includes a leakage on a first resource block of downlink sub-band or a leakage on a reference resource.

11. The method of claim 1, wherein the state of the apparatus includes a PRACH leakage, the condition includes a leakage threshold, and the step of determining whether the state of the apparatus meets the condition includes:
determining whether the PRACH leakage exceeds the leakage threshold,
wherein the step of transmitting the PRACH within the SBFD slot to the network in the event that the state of the apparatus meets the condition includes:
transmitting the PRACH within the SBFD slot to the network in the event that the PRACH leakage exceeds the leakage threshold and a PRACH preamble format of the PRACH is with a slight bandwidth.

12. The method of claim 1, wherein the state of the apparatus includes a PRACH frequency resource position, the condition includes a center of an uplink sub-band of the SBFD slot, and the step of determining whether the state of the apparatus meets the condition includes:
determining whether the PRACH frequency resource position is close to the center of the uplink sub-band of the SBFD slot,
wherein the step of transmitting the PRACH within the SBFD slot to the network in the event that the state of the apparatus meets the condition includes:
transmitting the PRACH within the SBFD slot to the network in the event that the PRACH frequency resource position is close to the center of the uplink sub-band of the SBFD slot.

13. The method of claim 1, wherein the state of the apparatus includes a transmitting power for the PRACH, the condition includes a power threshold determined based on a PRACH frequency resource allocation, and the step of determining whether the state of the apparatus meets the condition includes:
determining whether the transmitting power for the PRACH falls below the power threshold determined based on the PRACH frequency resource allocation,
wherein the step of transmitting the PRACH within the SBFD slot to the network in the event that the state of the apparatus meets the condition includes:
transmitting the PRACH within the SBFD slot to the network in the event that the transmitting power for the PRACH falls below the power threshold determined based on the PRACH frequency resource allocation.

14. The method of claim 13, wherein the PRACH frequency resource allocation includes at least one of a center of an uplink sub-band of the SBFD slot and a number of resource blocks allocated for PRACH.

15. The method of claim 14, further comprising:
determining, by the processor, the power threshold according to the center of the uplink sub-band of the SBFD slot, wherein
the power threshold is determined to be a first value in an event that a PRACH frequency resource position is close to the center of the uplink sub-band of the SBFD slot, or
the power threshold is determined to be a second value in an event that the PRACH frequency resource position is not close to the center of the uplink sub-band of the SBFD slot, and the second value is lower than the first value.

16. The method of claim 15, wherein the power threshold is determined based on a look-up table including relations between a plurality of power thresholds and a plurality of PRACH frequency resource positions.

17. The method of claim 14, further comprising:
determining the power threshold according to the number of resource blocks allocated for PRACH, wherein
the power threshold is determined to be a first value in an event that the number of resource blocks allocated for PRACH is equal to a first number, or
the power threshold is determined to be a second value in an event that the number of resource blocks allocated for PRACH is equal to a second number which is lower than the first number,
wherein the first value is lower than the second value.

18. The method of claim 15, wherein the power threshold is determined based on a look-up table including relations between a plurality of power thresholds and a plurality of numbers of resource blocks allocated for PRACH.

19. The method of claim 14, further comprising:
determining the power threshold according to the center of the uplink sub-band of the SBFD slot and the number of resource blocks allocated for PRACH, wherein
the power threshold is determined to be a first value in an event that a PRACH frequency resource position is close to the center of the uplink sub-band of the SBFD slot and the number of resource blocks allocated for PRACH is equal to a first number, or
the power threshold is determined to be a second value in an event that the PRACH frequency resource position is not close to the center of the uplink sub-band of the SBFD slot and the number of resource blocks allocated for PRACH is equal to a second number which is lower than the first number,
wherein the first value is lower than the second value.

20. The method of claim 19, wherein the power threshold is determined based on a look-up table including relations between a plurality of power thresholds, a plurality of PRACH frequency resource positions and a plurality of numbers of resource blocks allocated for PRACH.
